(19) United States
(12) Patent Application Publication
(10) Pub. No.: US 2026/0288132 A1
(43) Pub. Date: Sep. 24, 2026

(54) PROCESS AUTOMATION SERVER ANOMALY DETECTION USING MACHINE LEARNING

(71) Applicant: Yokogawa Electric Corporation, TOKYO (JP)

(72) Inventors: Vien Nguyen, Frisco, TX (US); Patrick Clay, Frisco, TX (US); Rabi Gurung, Calgary, CA (US); Andrew Keller, Lewisville, TX (US)

(21) Appl. No.: 19/086,966

(22) Filed: Mar. 21, 2025

(51) Int. Cl. G05B 23/02; G06F 11/1446

(52) U.S. Cl. CPC G05B 23/0275; G05B 23/0264; G06F 11/1458

(57) ABSTRACT

Implementations obtain a current set of operating data that includes multiple disparate types of data and for each of the multiple disparate types of data, a corresponding most recently determined instance thereof. The current set of operating data is processed using a trained machine learning model to generate output that indicates a current operating condition of a process automation server. The process automation server operates on server hardware that is located within a process automation facility, and controls one or more aspects of a process performed within the process automation facility. Based on the output generated using the machine learning model, a determination is made regarding whether the current operating condition of the process automation server is normal. In response to determining that the current operating condition of the process automation server is not normal, automatic performance of remediating action(s) is caused.

### BACKGROUND

In process automation control it is critical to monitor for the presence of abnormal conditions in the process that is being automated. For example, temperature readings, from temperature sensors in a process automation facility or an actuator controlling a valve, can be processed to monitor for any abnormal temperatures in vats, piping, equipment, and/or other component(s) of the process being automated in the process automation facility. As another example, pressure readings, from pressure sensors in the process automation facility, can be processed to monitor for abnormal pressures, vats, piping, equipment, and/or other components of the process.

Accordingly, with many current process automation setups sensor readings, I/O readings, and/or other reading(s) can be monitored for the presence of abnormal conditions in the process that is being automated. Such sensor readings, I/O readings, and/or other reading(s) being monitored can be generated by, provided by, and/or analyzed by a server, such as a server operating on a DCN located in a process automation facility.

However, there are situations where the server is operating abnormally due to memory leaks, hardware issues, software issues, CPU bandwidth constraints, network bandwidth constraints, and/or other issue(s). In such situations, sensor readings, I/O readings, and/or other reading(s) being monitored may not reflect true values. For example, if the server is operating abnormally it may still be reporting a stale temperature reading from a temperature sensor despite the temperature reading having actually updated to a different value.

However, such abnormal server operation is not typically monitored for in process automation control and/or any such monitoring has deficiencies. This can lead to the occurrence of suboptimal and/or unsafe operating conditions in the process automation facility. For example, a stale sensor reading being reported by the server, due to abnormal operation by the server, can result in the automated process not being adapted appropriately, an alarm not being triggered, and/or other adaptation(s) failing to be made, any of which can lead to suboptimal and/or unsafe operating conditions.

### SUMMARY

Implementations disclosed herein relate to detecting an abnormal operating condition of a server that is utilized in process automation control. The server can be, for example, a server operating on a distributed control node (DCN) located in a process automation facility, such as DCN that actually controls one or more aspects of process automation (e.g., actually instructing I/O(s), actually sending command(s) over a network, and/or performing other control action(s)). For example, the server can be software executing on the DCN and can be the only software executing on the DCN or can be executing on the DCN in parallel with other software also executing on the DCN (e.g., in parallel with function block(s) utilized in process automation control). More particularly, implementations relate to training and/or utilizing a machine learning model for use in processing real time operating data to generate output that reflects an operating condition of the server, such as output that indicates whether the operating condition is normal or abnormal. When the output indicates an abnormal operating condition, remediating action(s) can be automatically performed, such as causing human perceptible alert(s) to be rendered, initiating a backup server, and/or restarting the server. The real time operating data that is processed can include, for example, CPU bandwidth data, memory usage data, network status data, diagnostic data being generated by the server (e.g., quantity of client connections, session statistics, uptime, and/or other diagnostic data), server logs, application logs, and/or other data. In these and other manners, abnormal operation of the server, that would lead to suboptimal and/or unsafe operating condition(s), can be proactively detected through processing of real time operating data, and remedied such that any such negative effect(s) are minimized and/or avoided.

In training the machine learning model, implementations can generate training instances that include training instance input of actual historical operating data during a duration of time and training instance output that reflects a supervised label for an operating condition, of the server, at a conclusion of the duration of time. The duration of time can be, for example, an instantaneous snapshot, a 500 millisecond duration, a 5 second duration, a one minute duration, or other duration. The supervised label can be a binary label indicative of one of normal or abnormal, or a non-binary label such as one of normal, abnormal condition 1 (e.g., memory leak), … abnormal condition N (e.g., CPU bandwidth issue). The supervised label can be generated based on user interface input of human(s). For example, an abnormal supervised label can be generated for corresponding training instance input based on a human providing, via an HMI in the process automation facility, input(s) that indicate a problem with the server near a time of the historical operating data of the training instance input. As another example, an abnormal supervised label can be generated for corresponding training instance input based on a human providing an abnormal label based on post-hoc review of corresponding training instance input.

The training instances can be used to train the machine learning model prior to its deployment for real time monitoring for abnormal conditions. Optionally, the machine learning model can continue to be trained based on supervised feedback, from humans, during its deployment for real time monitoring for abnormal conditions. For example, a human confirmation of a machine learning model detected anomaly can be used as a positive supervision signal to further train the model. As another example, a human rejection of a machine learning model detected anomaly can be used as a negative supervision signal to further train the model. Continuing to train the machine learning model during its deployment can improve the accuracy (e.g., precision and/or recall) of the machine learning model in the process automation environment in which it is deployed. In some implementations, the machine learning model can be trained based on historical operating data from multiple disparate process automation facilities (e.g., in different geographic locations, performing different processes, etc.). In some of those implementations, the machine learning model is initially trained based on historical operating data from multiple disparate process automation facilities, then subsequently fine-tuned (i.e., further trained) based on historical operating data that is from a particular process automation facility in which the fine-tuned machine learning model is to be deployed. Fine-tuning the machine learning model based on historical operating data from a particular process automation facility can ensure that the fine-tuned machine learning model accurately identifies abnormal operating conditions of the server in the particular process automation facility. Further, initial training of the machine learning model based on historical operating data from multiple disparate process automation facilities can increase the robustness and/or accuracy of the machine learning model and/or can reduce the quantity of training instances, that are particularized to the particular process automation facility, that are needed for training to achieve a given level of robustness and/or accuracy.

In use, the machine learning model is utilized to process real time operating data (e.g., of a duration and type that conforms to that on which it was trained) to generate output that reflects an operating condition of a server, such as output that indicates whether the operating condition is normal or abnormal. When the output indicates an abnormal operating condition, remediating action(s) can be automatically performed, such as causing human perceptible alert(s) to be rendered, initiating a backup server (e.g., a twin of the server, that can optionally be already running in parallel), and/or restarting the server.

As a non-limiting example of some implementations disclosed herein, consider a large-scale chemical plant where numerous sensors and actuators are controlled by a server running on a distributed control node (DCN). The server can manage critical process(es) such as reactor temperature regulation, material flow control, and pressure maintenance. The server can begin to exhibit unusual behavior: CPU utilization spikes erratically, CPU utilization is abnormally low, memory consumption steadily increases (indicating a potential leak), network latency increases, a sharp drop in quantity of client connections, a sharp increase of at least a threshold quantity of client connections, a significant change in a quantity of active sessions, and/or other unusual behavior. A machine learning model, trained on historical data from this plant and optionally on historical data from other facilities, can be used to process real-time data directly or indirectly reflecting these symptoms, including processor load from a CPU performance monitor, memory utilization from the operating system, and/or network ping times. For example, processor(s) of an additional DCN, that is separate from the DCN running the server, can receive the real-time data and process it using the machine learning model, which can be stored (e.g., in memory of) at the additional DCN. Output that is generated, based on processing using the machine learning model, indicates a high likelihood of an abnormal server condition. Consequently, remediating action(s) can be triggered. For example, a human-perceptible alert is generated on an operator’s console, displaying details of the anomaly (CPU overload, memory leak) and suggesting a server restart, suggesting switching to a standby redundant DCN, and/or suggesting other remediation action(s). As another example, a backup server, which has been running in parallel in a “hot standby” mode, can additionally or alternatively be seamlessly activated to take over the server’s control functions, preventing any disruption to the ongoing process while the primary server is investigated and addressed.

As another non-limiting example of some implementations disclosed herein, consider a scenario in a large-scale offshore oil platform. This platform relies heavily on a network of servers to manage various aspects of its operations, including drilling controls, safety systems, and power management. These servers, running on DCNs, collect data from thousands of sensors and control hundreds of actuators. One server responsible for managing the platform’s emergency shutdown system (ESD) begins experiencing intermittent network connectivity issues and a gradual increase in its disk I/O latency. Simultaneously, another server managing power distribution logs recurring errors related to a specific software module. Utilizing disparate data inputs such as network latency (e.g., using a ping monitor), disk I/O wait times (captured via system performance metrics), and error logs (captured via log aggregation) a machine learning model can be employed to assess server health in real-time. In the case of this example platform, processor(s) on an additional DCN (separate from those with the potentially compromised servers) can utilize the machine learning model to process the data inputs and generate output that indicates server health. Upon detection of server abnormality, appropriate remediating action(s) can be initiated such as temporarily activating an alternate system (e.g., temporarily redirecting traffic to a redundant system) and simultaneously triggering diagnostic protocols on potentially compromised servers. By detecting such server-level anomalies and their impact across multiple operations, preventative action(s) can be implemented, and overall operational efficiency can be improved, while additionally mitigating potential hazards and preventing costly downtime and potential accidents on the offshore platform.

More generally, various implementations disclosed herein are directed to obtaining a current set of operating data, where the current set of operating data includes multiple disparate types of data and for each of the multiple disparate types of data, a corresponding most recently determined instance thereof. The current set of operating data is processed using a trained machine learning model to generate output that indicates a current operating condition of a process automation server. The process automation server operates on server hardware that is located within the process automation facility, and the process automation server controls one or more aspects of a process performed within the process automation facility. Based on the output generated using the machine learning model, a determination is made regarding whether the current operating condition of the process automation server is normal. In response to determining, based on the output generated using the machine learning model, that the current operating condition of the process automation server is not normal, automatic performance of at least one remediating action that seeks to remedy the not normal current operating condition of the process automation server is caused.

Those and other Implementations disclosed herein can mitigate (e.g., eliminate) various drawbacks with current techniques that fail to adequately monitor server operating conditions, potentially leading to inaccurate sensor data and subsequent process control errors. For example, by utilizing a trained machine learning model to analyze real-time operating data, the system can proactively detect anomalies such as memory leaks or CPU bandwidth constraints that might otherwise go unnoticed. As another example, automated remediating actions, triggered by the machine learning model based detection of an abnormal server condition, can rectify issues before they escalate into more significant problems that would affect the overall process automation facility.

In some implementations, the current set of operating data that is utilized by the machine learning model includes several distinct types of data, each reflecting an operating state of a component within the process automation facility. Examples of these data types include processor data, reflecting how much a hardware processor is being used; memory data, reflecting the extent to which hardware memory is being utilized; network data, showing the communication network’s status; and/or log data, pulled from the server’s logs. For instance, the processor data could show that the server is experiencing unusually high CPU utilization, indicating a potential problem. Similarly, the memory data might reveal a memory leak, where the server is gradually consuming more and more memory over time.

In some cases, where the disparate types of data include processor data, the processor is operating the server that is being monitored. For instance, the machine learning model may be processing processor load data from the very CPU on which the process automation server is operating. Alternatively, or additionally, where the disparate types of data include the memory data, the hardware memory being reflected by the memory data is utilized in operating the server. As an illustration, the machine learning model may be monitoring memory usage from the same physical memory modules that the process automation server is actively using.

Upon determining that the server is not operating normally, a variety of remediating actions can be initiated. One action can be rendering a human perceptible alert with information on what is wrong with the server. For example, if the server has a memory leak, a diagnostic display may automatically appear for the human(s) to see (e.g., on a computer monitor that is part of an HMI). Additionally or alternatively, upon determining that the server is not operating normally, a backup server can take over the process automation control responsibilities (e.g., automatically). For example, if a server exhibits high CPU usage and becomes unresponsive, a pre-configured backup server may seamlessly take over its duties.

In some instances, where a backup server is utilized, the backup server may already be running on separate hardware, in preparation to control aspects of the automated process, before the primary server’s operating condition is determined to be not normal. This means the backup server is standing by, ready to assume control, but is not actively engaged in process control. The process of having the backup server take over the process includes having the backup server to initiate actively controlling aspects of the process (e.g., after the machine learning model determines that the primary server is exhibiting abnormal operation). For instance, the backup server may continuously synchronize its data with the primary server, and upon detection of a failure in the primary server, it seamlessly takes over control without any interruption.

The output generated by the machine learning model may not simply be a binary indication of “normal” or “abnormal.” The output can reflect a non-binary likelihood (e.g., a probability, or a value on a scale) that the server is not operating normally. Based on this likelihood, the system can select an appropriate remediating action from a range of possible actions. This selection can be governed by certain conditions. For instance, if the likelihood exceeds a threshold, a specific action might be taken; otherwise, an alternative action is selected. In an example implementation, if the machine learning model’s output indicates a relatively low probability of an abnormal condition, a diagnostic process may be automatically initiated and/or the alert presented to an operator may be of a relatively low urgency level, while a high likelihood may trigger an automatic server restart or failover to a redundant system and/or the alert presented to an operator may be of a relatively high urgency level.

In some examples, the server that is being monitored operates on server hardware including a distributed control node (DCN) that has I/Os (inputs and outputs). Sensors and actuators can be connected to the I/Os of the DCN. As an illustration, the server could be running on a DCN that is directly connected to temperature sensors in a chemical reactor, receiving real-time temperature readings through its I/Os. Additionally or alternatively, the DCN may be directly connected to valves which allow it to control a flow rate of one or more component chemicals into the chemical reactor.

In some implementations, the current set of operating data includes not just the most recently determined instance of each data type, but also the next most recently determined instance. For example, in addition to obtaining the most recent CPU usage reading, the system also obtains the immediately preceding CPU usage reading. Utilizing a history, i.e., multiple instances in time, of a reading may improve accuracy in detecting abnormal operating conditions of a server, and in taking action to remedy those abnormal operating conditions.

Implementations can utilize human feedback regarding whether a remediating action did indeed result in successful remediation (or some other assessment regarding the usefulness of the remediating action in view of a certain operating dataset). This human feedback can then be used to further train the machine learning model. Specifically, a supervised label is determined based on the human feedback and then, together with the current set of operating data that prompted the remediating action, can be used as a training instance to further train the machine learning model. By receiving and using human feedback, and continuing to train, the machine learning model becomes more tailored to the specific process automation facility where it is deployed. For example, if an operator confirms that restarting the server resolved an issue flagged by the machine learning model, this information can be fed back into the model to reinforce its decision-making process.

The trained machine learning model is, in some instances, initially trained based on historical data to improve anomaly-detection accuracy. Each of the historical training instances includes training instance input with corresponding real historical operating data and training instance output that includes a corresponding supervised label for the corresponding real historical operating data. In some of those instances, historical training instances may come from multiple disparate process automation facilities. Training can occur on historical operating data from various process automation facilities that differ from the facility where the trained machine learning model will be deployed (e.g., different types of facilities, different geographic locations, etc.). After this initial training based on historical data from multiple disparate process automation facilities, fine tuning (i.e., additional training) can occur on historical operating data from the process automation facility where the machine learning model will be deployed. As an example, the machine learning model may initially be trained using server performance data collected from chemical plants across different geographic regions and only later be refined using data specific to a particular plant. This ensures that the model is both broadly applicable and finely tuned to the unique characteristics of its deployment environment.

The above description is provided as an overview of some implementations of the present disclosure. Further description of those implementations, and other implementations, are described in more detail below.

In addition, some implementations include one or more processors of one or more devices (e.g., DCN(s)), where the one or more processors are operable to execute instructions stored in associated memory, and where the instructions are configured to cause performance of any of the aforementioned methods. The processor(s) can include various hardware processors such as central processing unit(s) (CPU(s)), application-specific integrated circuit(s) (ASIC(s)), field-programmable gate array(s) (FPGA(s)), graphics processing unit(s) (GPU(s)), digital signal processor(s) (DSP(s)), and/or other processor(s). Some implementations additionally or alternatively include one or more transitory or non-transitory computer readable storage media storing computer instructions executable by one or more processors to perform any of the methods disclosed herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which implementations disclosed herein can be implemented.

FIG. 2 illustrates an example illustrating how components of FIG. 1 can interact in accordance with implementations disclosed herein.

FIG. 3 illustrates an example method of training a server anomaly machine learning model in accordance with implementations disclosed herein.

FIG. 4 illustrates an example method of utilizing a server anomaly machine learning model to monitor for abnormal operation of a process automation server, and causing remediating action(s) to be performed in response to detecting abnormal operation.

FIG. 5 illustrates an example computing device.

### DETAILED DESCRIPTION

Implementations disclosed herein relate to detecting an abnormal operating condition of a server that is utilized in controlling an at least partially automated process of a process automation facility. As used herein, an “at least partially automated process” includes any process cooperatively implemented within a process automation system by multiple devices with little or no human intervention. One common example of an at least partially automated process is a process loop in which one or more actuators are operated automatically (without human intervention) based on output of one or more sensors. Some at least partially automated processes can be sub-processes of an overall process automation system workflow, such as a single process loop mentioned previously. Other at least partially automated processes can include all or a significant portion of an entire process automation system workflow. In some cases, the degree to which a process is automated can exist along a gradient, range, or scale of automation. Processes that are partially automated, but still require human intervention, may be at or near one end of the scale. Processes requiring less human intervention may approach the other end of the scale, which represents fully autonomous processes. Process automation in general may be used to automate processes in a variety of domains, e.g., manufacture, development, and/or refinement of chemicals (e.g., chemical processing), catalysts, machinery, and/or other domain(s).

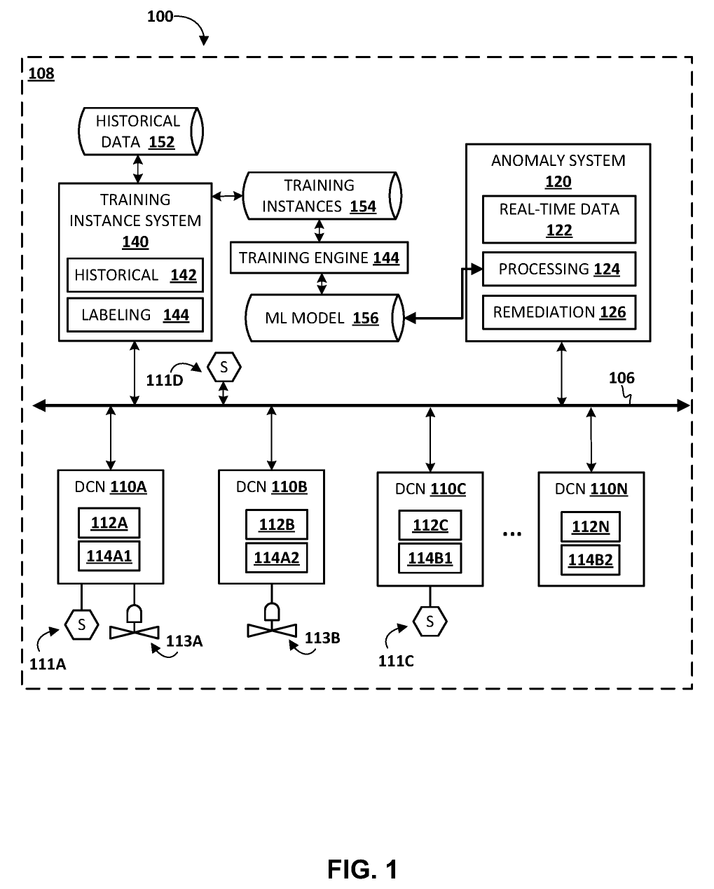

Referring now to FIG. 1, an example environment 100 in which various aspects of the present disclosure can be implemented is depicted schematically. Environment 100 includes a process automation system 108 that can be implemented in various industrial settings, such as part of a chemical processing plant, an oil or natural gas refinery, a catalyst factory, a manufacturing facility, or other industrial setting(s). Process automation system 108 is illustrated in FIG. 1 as including: a process automation network 106; sensors 111A, 111C, and 111D; actuators 113A and 113B; training instance system 140; training engine 144; anomaly system 120; and distributed control nodes (DCNs) 110A-N. The process automation system 108 can include various additional components such as tens, hundreds, or thousands of additional sensors and/or tens, hundreds, or thousands of additional actuators. However, those are not illustrated in FIG. 1 for the sake of simplicity.

Process automation network 106 can be implemented using various wired and/or wireless communication technologies, including but not limited to the Institute of Electrical and Electronics Engineers (IEEE) 802.3 standard (Ethernet), IEEE 802.11 (Wi-Fi), cellular networks such as 3GPP Long Term Evolution (“LTE”) or other wireless protocols that are designated as 3G, 4G, 5G, and beyond, and/or other types of communication networks of various types of topologies (e.g., mesh). Process automation is often employed in scenarios in which the cost of failure tends to be large, both in human safety and financial cost to stakeholders. Accordingly, in various implementations, process automation network 106 can be configured with redundancies and/or backups to provide high availability (HA) and/or high quality of service (QOS). Additionally, nodes that exchange data over process automation network 106 can implement time-sensitive networking (TSN) to facilitate time synchronization and/or real-time control streams. Various nodes/devices are operably coupled with process automation network 106, such as anomaly system 120 and DCNs 110A-N.

DCNs 110A, 110B, 110C, and 110N are illustrated in FIG. 1. However, it is noted that, as indicated by the ellipsis between DCN 110C and DCN 110N, additional (e.g., hundreds of or even thousands of) DCN(s) can be provided in process automation system 108. Some DCNs in process automation system 108 can have input(s)/output(s) (I/O(s)) for coupling with sensor(s), HMI(s), actuator(s), and/or other components. Other DCN(s) in process automation system 108 can optionally omit I/O(s).

DCN 110A is coupled, via respective I/Os, to an actuator (e.g., a valve) 113A. The actuator 113A, and other actuators described herein, can be an electric, hydraulic, mechanical, and/or pneumatic component that is controllable to affect some aspect of a process automation workflow that occurs at process automation facility 108. DCN 110A is also coupled, via respective I/Os, to a sensor 111A that provides sensor data indicating, for example, flow rate of a corresponding fluid flow. Sensors described herein can take various forms, including but not limited to a pressure sensor, a temperature sensor, a flow sensor, various types of proximity sensors, a light sensor (e.g., a photodiode), a pressure wave sensor (e.g., microphone), a humidity sensor (e.g., a humistor), a radiation dosimeter, a laser absorption spectrograph (e.g., a multi-pass optical cell), and/or other form(s).

DCN 110A includes processor(s) that can utilize associated memory (and corresponding instructions stored therein) for implementing corresponding function(s) of the DCN 110A. Those function(s) include implementing function block(s) 112A of DCN 110A, which can be stored in some of the associated memory. The function block(s) 112A can define one or more aspects of sensor monitoring and/or actuator control. In some implementations, each of the function block(s) 112A is a corresponding software model that contains input/output variable(s), through variable(s), internal variable(s), and/or an internal behavior description of the function(s) to be performed by the function block. As a non-limiting example, one of the function block(s) 112A of DCN 110A can control the actuator 113A based on sensor data from sensor 111A and/or in dependence on output(s) from other function block(s), such as other function block(s) implemented at DCN 110A and/or at other DCN(s).

The function(s) implemented by processor(s) of DCN 110A can optionally also include implementing a server 114A1. The server 114A1 can operate as a primary instance and can perform one or more of various functions such as interacting with (e.g., receiving data from and/or sending data to) function block(s) 112A and/or other function block(s) (e.g., of other DCN(s)). In some implementations, the server 114A1 is a software application that makes industrial automation data accessible to clients, such as client(s) implementing function block(s) 112A and/or client(s) of other DCN(s) 110B-N, through a standardized, secure, and platform-independent protocol, enabling machine-to-machine and PC-to-machine communication. In some implementations, the server 114A enables clients to read data from the server 114A1, write data to the server 114A1, subscribe to notification(s) from the server 114A1 , and/or call method(s) executed by the server 114A1. In some implementations, the server 114A1 is Open Platform Communications (OPC) Unified Architecture (UA) server.

DCN 110B is coupled, via respective I/Os, to an actuator 113B. DCN 110B is not directly coupled, via respective I/Os, to any sensor, but can optionally be in network communication with sensor 111D and/or other sensor(s). DCN 110B includes processor(s) that can utilize associated memory (and corresponding instructions stored therein) for implementing corresponding function(s) of the DCN 110B. Those function(s) include implementing function block(s) 112B of DCN 110B, which can be stored in some of the associated memory. The function block(s) 112B can define one or more aspects of sensor monitoring and/or actuator control. As a non-limiting example, one of the function block(s) 112B of DCN 110B can control the actuator 113B based on sensor data from sensor 111D and/or in dependence on output(s) from other function block(s), such as other function block(s) implemented at DCN 110B and/or at other DCN(s).

The function(s) implemented by processor(s) of DCN 110B can optionally also include implementing server 114A2 and operating it as a secondary instance as a backup to the server 114A1 of DCN 110A. In operating the server 114A2 as a secondary instance as a backup to server 114A1 of DCN 110A, the server 114A2 can be executing in parallel to the server 114A1 (e.g., in a hot standby mode), but not actively controlling any process automation function of process automation system 108. Rather, in the event of detection of non-normal operating condition(s) with regard to server 114A1 (e.g., as described herein), the server 114A2 can immediately be activated so as to take over control of at least some process automation function(s) being performed by the server 114A1 prior to the non-normal operating condition(s) being detected. For example, when operating as a primary instance, the server 114A1 can be the server that enables clients to read data, write data, subscribe to notifications, and/or call methods executed by the server 114A1. When operating as a secondary instance, the server 114A2 can be executing in parallel to the server 114A1, but not actively enabling clients to read data, write data, subscribe to notifications, and/or call methods executed by the server 114A2. Instead, the server 114A2 can perform those further functions only when the server 114A1 is determined to be operating abnormally and the server 114A2 takes over as a primary instance in response thereto.

DCN 110C is coupled, via respective I/Os, to a sensor 111C. DCN 110C is not directly coupled, via respective I/Os, to any actuator, but can optionally be in network communication with actuator(s). DCN 110C includes processor(s) that can utilize associated memory (and corresponding instructions stored therein) for implementing corresponding function(s) of the DCN 110C. Those function(s) include implementing function block(s) 112C of DCN 110C, which can be stored in some of the associated memory. The function block(s) 112C can define one or more aspects of sensor monitoring and/or actuator control. As a non-limiting example, one of the function block(s) 112C of DCN 110C can process sensor data from sensor 111C, and/or other sensor(s) and, based on such processing, generate alarms (e.g., graphical and/or audible alerts provided via HMI(s)), indirectly control actuators through process automation network 106 and other DCNs, and/or perform other control action(s).

The function(s) implemented by processor(s) of DCN 110C can optionally also include implementing a server 114B1. The server 114B1 can operate as a primary instance and can perform one or more of various functions and can supplement functions performed by server 114A1/114A2. In some implementations, the server 114B1 is a software application that makes industrial automation data accessible to clients through a standardized, secure, and platform-independent protocol, enabling machine-to-machine and PC-to-machine communication.

DCN 110N is not directly coupled to any actuator or to any sensor, but can optionally be in network communication with actuator(s) and/or sensor(s). DCN 110N includes processor(s) that can utilize associated memory (and corresponding instructions stored therein) for implementing corresponding function(s) of the DCN 110N. Those function(s) include implementing function block(s) 112N of DCN 110N, which can be stored in some of the associated memory. The function block(s) 112N can define one or more aspects of sensor monitoring and/or actuator control. As a non-limiting example, one of the function block(s) 112N of DCN 110N can process sensor data from sensor 111D, and/or other sensor(s) and, based on such processing, generate alarms (e.g., graphical and/or audible alerts provided via HMI(s)), indirectly control actuators through process automation network 106 and other DCNs, and/or perform other control action(s).

The function(s) implemented by processor(s) of DCN 110B can optionally also include implementing server 114B2 and operating it as a secondary instance as a backup to the server 114B1 of DCN 110C. In operating the server 114B2 as a secondary instance as a backup to server 114B1 of DCN 110C, the server 114B2 can be executing in parallel to the server 114B1 (e.g., in a hot standby mode), but not actively controlling any process automation function of process automation system 108. Rather, in the event of detection of non-normal operating condition(s) with regard to server 114B1 (e.g., as described herein), the server 114B2 can immediately be activated so as to take over control of at least some process automation function(s) being performed by the server 114B1 prior to the non-normal operating condition(s) being detected.

Anomaly system 120 is illustrated as a separate component in process automation network 106. However, it is noted that, some or all of the anomaly system 120 can be executed at one or more of the DCNs 110A-N. For example, DCN 110A can execute an instance of anomaly system 120. In some implementations, some or all of the anomaly system 120 can be executed at additional hardware component(s) that are separate from DCN(s), such as at local non-DCN computer devices that are directly connected to the process automation network 106.

Likewise, training instance system 140 and training engine 144 are illustrated as a separate component in process automation network 106. However, it is noted that, some or all of the training instance system 140 and training engine 144 can be executed at one or more of the DCNs 110A-N. For example, DCN 110A can execute an instance of training instance system 140. In some implementations, some or all of training instance system 140 and training engine 144 can be executed at additional hardware component(s) that are separate from DCN(s), such as at local non-DCN computer devices that are directly connected to the process automation network 106. Further, in some implementations the training instance system 140 and/or the training engine 144 are not coupled to the process automation network 106 and/or are not included in the process automation system 108. For example, in implementations where the ML model 156 is not further trained based on feedback from operation of the process automation system 108, the training instance system 140 and training engine 144 may be omitted from being included as part of the process automation system 108 (though they could still be previously utilized in training the ML model 156).

Training instance system 140 generates training instances for training ML model 156 and stores them in training instances database 156. The training instance system 140 can include a historical module 142 and a labeling module 144. In generating a training instance, the historical module 142 can generate input of the training instance based on historical data in historical data database 152. The historical data database 152 can store instances of data from the process automation system 108 and/or from other process automation systems. Various types of data can be included, and each type can reflect a corresponding operating state of a corresponding component of a corresponding process automation system and can include a corresponding timestamp of other temporal marker. For example, the historical data database 152 can include, for the process automation system 108, instances of processor data for processor(s) that implement server 114A1, instances of memory data for memory utilized in implementing server 114A1, instances of network data that reflect status of process automation network 108, and/or instances of log data that reflects log entries generated by server 114A1. The instances of data can be received at the same or differing frequencies. For example, instances of processor data and memory data can be received every 100 milliseconds and the historical data database 152 can store all of those instances, while instances of log data may only be received every 10 seconds.

In generating input of a training instance, the historical module 142 can select a set of the historical data in historical data database 152. For example, if the ML model 156 is being trained to process an instantaneous snapshot of data relevant to a server, then the historical module 142 can select a single instance of processor data relevant to the server, a single instance of memory data relevant to the server, a single instance of network data relevant to the server, and a single instance of log data relevant to the server. The historical module 142 can select the single instances based on them all having the same timestamp or based on them being the instances that are closest to a timestamp (e.g., when some of the data is received at differing frequencies). As another example, if the ML model 156 is being trained to process a duration of data, then the historical module 142 can select multiple instances of processor data over the duration, multiple instances of memory data over the duration, multiple instances of network data over the duration, and multiple instances of log data over the duration. For instance, if the duration is a 5 second duration then the historical module 142 can select the multiple instances based on them all having a corresponding timestamp within a 5 second duration of time.

The labeling module 144 generates supervised labels for corresponding sets of historical data. Put another way, the labeling module 144 generates supervised labels to pair with inputs, of training instances, generated by the historical module 142. In some implementations and/or for some supervised labels, a supervised label for a set of historical data can be based on human feedback, such as feedback from an operator or a process automation facility that indicates a problem with a corresponding server or feedback from a reviewer analyzing the set of historical data and/or other data. In some implementations and/or for some supervised labels, a supervised label for a set of historical data can be automatically generated. For example, the labeling module 144 can automatically generate a non-normal supervised label for a set of historical data relevant to a server based on the server crashing or restarting within a threshold duration of time of timestamp(s) for the set of historical data. For instance, if the set of historical data is all timestamped with a first timestamp, and a server crash was detected within one second of the first timestamp, then the labeling module 144 can automatically generate a non-normal supervised label. In some implementations, the supervised labels can be binary such as one of “0” (e.g., “normal”) or “1” (e.g., “not normal”). In some other implementations, the supervised labels can be non-binary. For example, the supervised labels can be one of “0” (e.g., “normal”), “0.5” (e.g., “slightly abnormal”) or “1” (e.g., “abnormal”). As another example, the supervised labels can be one of “0” (e.g., “normal”) or “1” (e.g., “not normal”) for each of multiple server conditions such as “network connectivity”, “processor load”, and “memory load”.

As a particular example, a set of historical data could include data representing operating data, from a corresponding process automation facility and from a continuous 500 milliseconds period of time, and the supervised label could indicate, based on human input, whether the operation of a server, such as server 114A1, was normal or non-normal during and/or at the conclusion of that 500 milliseconds. For instance, the supervised label can be a non-normal label if human feedback indicated an error during and/or at the conclusion of that 500 milliseconds. As another particular example, a set of historical data could include operating data from a corresponding process automation facility and from a continuous 5 second period of time, and the supervised label could indicate whether the operation of a server, such as server 114A1, was normal, non-normal due to a memory leak, non-normal due to CPU bandwidth constraints, or non-normal due to a software bug.

The training instances, generated by the training instance system 140, are stored at training instance database 154. Training engine 144 utilizes the training instances stored in training instance database 154 to train the ML model 156. For example, the training engine 144 can utilize a supervised training technique, such as backpropagation and gradient descent, to train the ML model 156 based on the training instances stored in the training instance database 154. The ML model 156 can be trained for use in generating output that reflects a current operating condition of a server, that reflects a likelihood that a server is not operating normally, and/or that indicates a severity of a server abnormality. The ML model 156 can be of various types and/or architectures, which can optionally depend on types of input data to be processed by the ML model 156 and/or types of output data to be generated by the ML model 156. For example, the ML model 156 can be a feedforward model, a recurrent neural network model, a support vector machine model, a decision tree model, a Bayes model, a regression model, a transformer model, or other type of model. For instance, the ML model can be a large language model and the input data can be in an unstructured and/or natural language format. As another particular example, the ML model 156 can be a feedforward neural network classifier model and the input data can be numerical data that is optionally discretized. For instance, processor data can be a discretized number whose magnitude represents the load of the CPU that the processor(s) utilize in implementing server 114A1. Similarly, memory data can be a discretized number that is also a measure of the load of memory that the processor(s) utilize in implementing server 114A1. As yet another instance, log data can be a numerical embedding of text, generated by processing text of log entry/entries using an encoder model. In some implementations, the input data can include both unstructured input (e.g., free natural-language text) and structured input (e.g., a numerical embedding generated by processing the free natural-language text).

The anomaly system 120 is illustrated with a real-time data module 122, a process module 124, and a remediation module 126. The real-time data module 122 obtains current real-time data from the process automation network 106 and/or from a local process automation network of the process automation system 108. The current real-time data reflects one or more current operating states of one or more components of a process automation system that are relevant to a server. For example, the current real-time data for server 114A1 can reflect processor data for DCN 110A and/or other DCN(s) reflecting how much of a corresponding hardware processor is being used (e.g., as a relative percentage), memory data for DCN 110A and/or other DCN(s) reflecting the extent to which hardware memory is being utilized (e.g., as a relative percentage), network data reflecting a status of the communication network 106 (e.g., bandwidth being utilized, latency, and/or other communication network status), and/or log data reflecting data generated by the server 114A1.

The real-time data module 122 provides the current real-time data to the processing module 124. The processing module 124 processes the current real-time data using the ML model 156. As described herein, the ML model 156 can be trained for use in generating output that reflects a current operating condition of a server, that reflects a likelihood that a server is not operating normally, and/or that indicates a severity of a server abnormality. Accordingly, based on processing using the ML model 156, output can be generated that indicates a current operating condition of a server and/or that indicates a current likelihood of abnormality of a server. For example, the output can reflect whether server 114A1 is operating normally or not.

Based on the output generated from processing the current real-time data using the ML model 156, the remediation module 126 determines whether the current operating condition of the server is normal. In response to determining, based on the output generated from processing the current real-time data using the ML model 156, that the current operating condition of the server is not normal, remediation module 126 can cause remediating action(s) to be taken. For example, remediating action(s) could include restarting the server, providing a warning to an operator via HMI, automatically diagnosing the server, initiating a backup instance of the server, and/or other action(s). For instance, if the real-time data module 122 provides the real-time data for server 114A1 to the processing module 124, and the processing module 124 determines, using the ML model 156, that the server 114A1 is operating abnormally, then the remediation module 126 can cause, via the process automation network 106, initiation of the backup server 114A2, which can become the primary instance of the server 114A1. As another instance, if the real-time data module 122 provides the real-time data for server 114A1 to the processing module 124, and the processing module 124 determines, using the ML model 156, that the server 114 A1 is operating abnormally, then the remediation module 126 can cause, via the process automation network 106, the server 114A1 to be restarted.

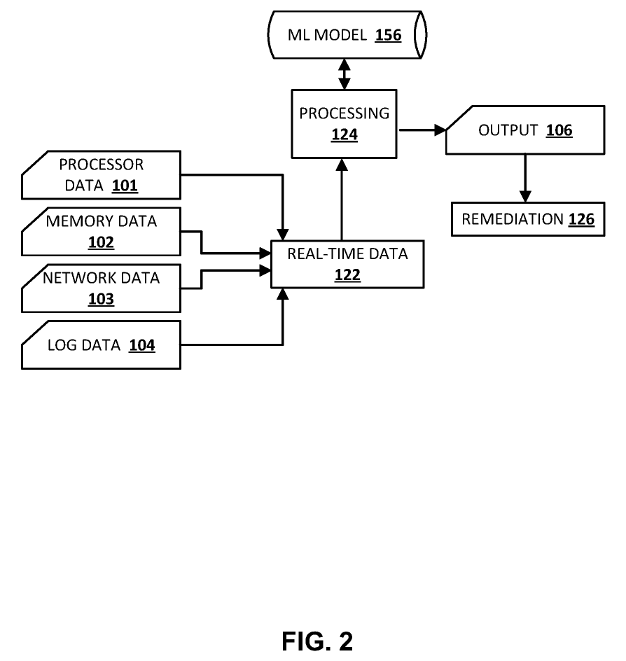

FIG. 2 illustrates an example illustrating how components of FIG. 1 can interact in accordance with implementations disclosed herein. In FIG. 2, the real-time data module 122, of anomaly system 120, is illustrated as receiving current real-time data that includes processor data 101, memory data 102, network data 103, and log data 104. For example, the processor data 101 can reflect current and/or recent CPU utilization of processor(s) that implement server 114A1, the memory data 102 can reflect current and/or recent memory utilization of memory utilized by server 114A1, the network data 103 can reflect current and/or recent performance of all or aspects of the process automation network 106, and the log data 104 can reflect current and/or recent log entries generated by server 114A1. The real-time data module 122 provides the current real-time data to the processing module 124. The processing module 124 utilizes the ML model 156 to process the current real-time data and generate output 106 that reflects a current operating condition of a server (e.g., server 114A1) and/or a current likelihood of abnormality of a server. The remediation module 126 determines, based on the output 106, whether the current operating condition of the server is normal. In response to determining, based on the output 106, that the current operating condition of the server is not normal, the remediation module 126 can cause remediating action(s) to be taken.

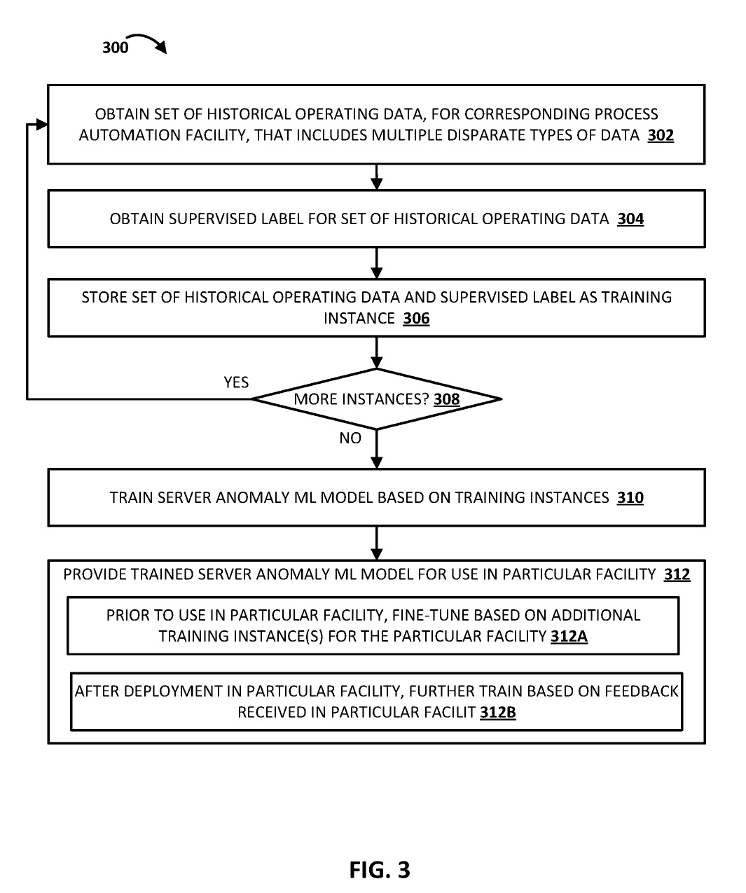

FIG. 3 is a flowchart illustrating an example method 300 of training a server anomaly machine learning model in accordance with implementations disclosed herein. For convenience, the operations of the flow chart are described with reference to a system that performs the operations. This system may include various components of various computer systems, such as processor(s) of training instance system 140 and/or training engine 144. Moreover, while operations of method 300 are shown in a particular order, this is not meant to be limiting. One or more operations may be reordered, omitted or added.

At block 302, the system obtains a set of historical operating data, for a corresponding process automation facility, that includes multiple disparate types of data. For example, the system can obtain a set of historical operating data that is for a given process automation facility and includes multiple disparate types of data such as processor data (e.g., relative percentage of CPU being utilized), memory data (e.g., relative percentage of memory being utilized), network data (e.g., relative percentage of network bandwidth being utilized, relative percentage of network latency being utilized, etc.), log data (e. g., relative percentage of log memory being utilized), and/or other type(s) of data.

The set of historical operating data obtained at an iteration of block 302 all relates to a corresponding particular server. For example, the set of historical operating data obtained at an iteration of block 302 can include processor data for processor(s) that implement the corresponding particular server, memory data for processor(s) that implement the corresponding particular server, network data for network(s) communicatively coupled with the corresponding particular server, etc. In some implementations, the set of historical operating data obtained at an iteration of block 302 can additionally or alternatively include data that is relevant to the corresponding particular server, but that is not specifically data directly produced by or directly attributable to the corresponding particular server. For example, the set of historical operating data obtained at an iteration of block 302 can additionally or alternatively processor data for DCNs that are communicatively coupled with processor(s) that implement the corresponding particular server, memory data for DCNs that are communicatively coupled with processor(s) that implement the corresponding particular server, temperature data generated by temperature sensor(s) of the corresponding process automation facility, humidity data generated by humidity sensors of the corresponding process automation facility, and/or other data that is not directly produced by or directly attributable to the corresponding particular server.

At block 304, the system obtains a supervised label for the set of historical operating data obtained at the most recent iteration of block 302. For example, the system can obtain a supervised label that is based on human feedback. As a particular example, the feedback can be from an operator physically present in the corresponding process automation facility and providing feedback in response to a human detected issue with a corresponding server. For instance, if a human operator manually restarts a server, then a supervised “non-normal” label can be generated for corresponding historical data (e.g., historical data whose timestamp(s) precede and are within a threshold duration of time of the server restart).As another particular example, the feedback can be from a reviewer that reviewed, and analyzed, corresponding historical data while outside of the corresponding process automation facility and determined, based on their review and analysis, whether the corresponding server is normal or not normal. For instance, if a reviewer determines that a set of historical data is abnormal, then a supervised “non-normal” label can be generated for the set of historical data. In some implementations or iterations of block 304, a supervised label can be one that is automatically generated without human intervention. For example, an automatic restart of a server (e.g., due to a crash) can generate automatically a “non-normal” label for corresponding historical data (e.g., historical data whose timestamp(s) precede and are within a threshold duration of time of the automatic restart). As yet another example, the system can obtain a “normal” label based on human feedback, lack of human feedback, and/or other signals. For instance, lack of any server restarts and lack of any negative human feedback during a period of time can be utilized to assign a “normal” supervised label to historical operating data from that period of time. Also, for instance, human feedback that indicates normal operation can be utilized to assign a “normal” supervised label to corresponding historical operating data.

At block 306, the system stores the set of historical operating data obtained at the most recent iteration of block 302 and the supervised label obtained at the most recent iteration of block 304 as a training instance. The training instance includes the set of historical operating data as input of the training instance and the supervised label as a supervised label of the training instance.

At block 308, the system determines whether to generate an additional training instance. For example, the system can determine whether to generate an additional training instance based on available processing resources (e.g., processing power) of the training instance system 140 and/or training engine 144, based on whether a threshold number of training instances have already been generated, based on whether unprocessed historical operating data is available, and/or other factor(s). If, at an iteration of block 308, the system determines to generate an additional training instance, the system proceeds back to block 302 to generate another training instance. If, at an iteration of block 308, the system determines not to generate an additional training instance, the system proceeds to block 310.

At block 310, the system utilizes the training instances to train the server anomaly machine learning model. For example, the system can utilize a supervised training technique, such as backpropagation and gradient descent, to train the server anomaly machine learning model based on the training instances. As described herein, the server anomaly machine learning model can be trained for use in generating output that reflects a current operating condition of a server, that reflects a likelihood that a server is not operating normally, and/or that indicates a severity of a server abnormality. The server anomaly machine learning model can be of various types and/or architectures.

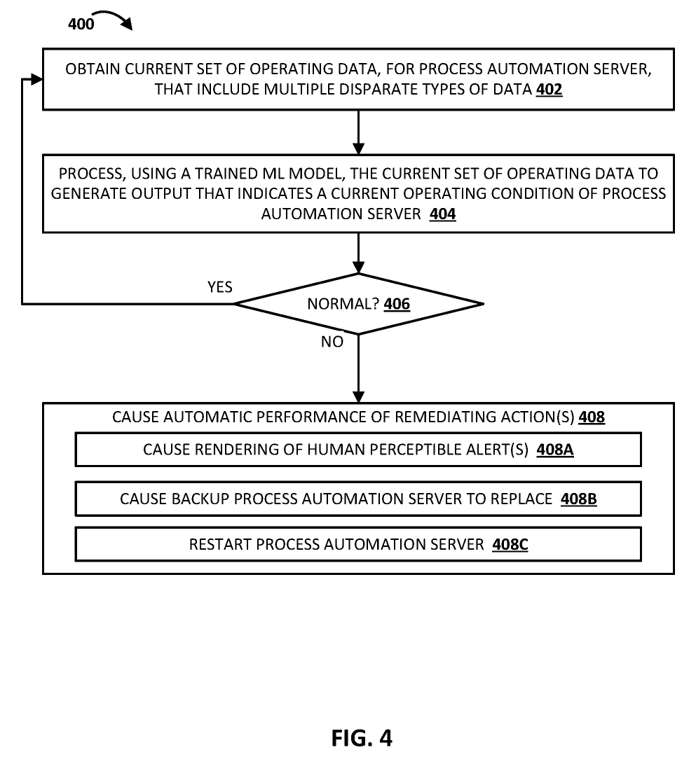

At block 312, the system provides the trained server anomaly machine learning model for use in a particular process automation facility. For example, the system can provide the trained server anomaly machine learning model for use in performing the method 400 of FIG. 4 within a particular process automation facility and in monitoring for abnormal operating condition(s) of a process automation server of the particular process automation facility.

In some implementations block 312 optionally includes sub-block 312A and/or sub-block 312B.

At sub-block 312A, prior to use of the trained server anomaly machine learning model in a particular process automation facility, the system fine-tunes the trained server anomaly machine learning model for the particular process automation facility. For example, the system can generate and/or obtain additional supervised training instances that are for the particular process automation facility (e.g., generated based on historical data that is from the particular process automation facility), and can fine-tune the trained server anomaly machine learning model based on further training using those additional supervised training instances. In this manner, the trained server anomaly machine learning model can be fine-tuned to become more accurate in detecting a current operating condition of a server of the particular process automation facility. In some implementations where sub-block 312A is implemented, the historical operating data used in one or more (e.g., all) of the iterations of block 302 can be for additional process automation facility/facilities that are distinct from the particular process automation facility. For example, blocks 302-310 can be performed to train a base server anomaly machine learning model, and then block 312A can be performed, for each of multiple additional process automation facilities, to fine-tune the base server anomaly machine learning model for each additional process automation facility.

At sub-block 312B, after deployment of the trained server anomaly machine learning model in a particular process automation facility, the system further trains the deployed trained server anomaly machine learning model based on feedback received at and/or generated in the deployed particular process automation facility. For example, the system can generate and/or obtain additional supervised training instances that are for the particular process automation facility (e.g., generated based on historical data that is from the particular process automation facility) and operator feedback or automatically generated supervised labels. In these and other manners, the deployed trained server anomaly machine learning model can be further trained to become more accurate in detecting an operating condition and/or abnormality of a server of the deployed particular process automation facility.

FIG. 4 is a flowchart illustrating an example method an example method 400 of utilizing a server anomaly machine learning model to monitor for abnormal operation of a process automation server, and causing remediating action(s) to be performed in response to detecting abnormal operation. For convenience, the operations of the flow chart are described with reference to a system that performs the operations. This system may include various components of various computer systems, such as processor(s) of a DCN. Moreover, while operations of method 400 are shown in a particular order, this is not meant to be limiting. One or more operations may be reordered, omitted or added.

At block 402, the system obtains a current set of operating data, for a process automation server, that includes multiple disparate types of data. For example, the system can obtain a set of current operating data that is for a given process automation server and includes multiple disparate types of data such as processor data, memory data, network data, log data, and/or other type(s) of data. At block 402, the system can obtain a current set of operating data that includes, for each of the multiple types, a most recent instance thereof. For example, a most recently received instance of processor data, a most recently received instance of memory data, a most recently received instance of network data, and a most recently received instance of log data. Optionally, additional instances can be included in the current set, such as the N most recent instances (where N is greater than one) or the instances received within a threshold duration of time relative to a current time (e.g., the last 5 seconds of data, the last 3 minutes of data, the last hour of data).

At block 404, the system processes, using a trained server anomaly machine learning model (e.g., trained using method 300), the current set of operating data to generate output that indicates the current operating condition of the process automation server.

At block 406, the system determines, based on the output, whether the current operating condition of the process automation server is normal. If, at an iteration of block 406, the system determines that the current operating condition of the process automation server is normal, the system proceeds back to block 402 to obtain another current set of operating data. If, at an iteration of block 406, the system determines that the current operating condition of the process automation server is not normal, the system proceeds to block 408.

At block 408, the system causes automatic (i.e., without human intervention) remediating action(s) to be performed. Block 408 can optionally include sub-block 408A, 408B, and/or 408C. For example, block 408 can include only one of sub-blocks 408A-C or can include multiple of sub-blocks 408-C.

At sub-block 408A, the system causes automatic rendering of one or more human perceptible alerts. For example, the one or more human perceptible alerts can be caused to be rendered on an HMI of a process automation facility to alert personnel in the process automation facility that the operating condition of a corresponding server is not normal. In implementations where the output generated at an iteration of block 404 indicates a type of abnormality, sub-block 408A one or more of the human perceptible alerts can reflect the type of abnormality that is indicated in the output. For instance, if the output indicates that there is a memory leak, the one or more human perceptible alerts can reflect (e.g., in natural language or symbolic visual form) the memory leak that is indicated in the output. In these and other manners, one or more people can be alerted to the type of abnormality, enabling them to more quickly determine and implement remediating action(s).

At sub-block 408B, the system causes a backup server to replace the process automation server that is not operating normally. For example, the system can switch primary operation from the server to a backup server that is already executing in parallel to the server or the system can automatically instantiate a backup server and cause the backup server to be the primary (e.g., by switching primary operation from the server to the instantiated backup server).

At sub-block 408C, the system causes the process automation server to be automatically restarted.

In some implementations, multiple instances of method 400 can be implemented within a given process automation facility in parallel with one another. In those implementations, each instance of method 400 can be for a separate process automation server of the given process automation facility. For example, one instance of method 400 can be implemented for a first process automation server and another instance of method 400 can be implemented for a second process automation server. In implementing method 400 for the first process automation server, the operating data obtained at block 402 can relate to the first process automation server and can be distinct (at least in part) from the operating data obtained at block 402 in implementing method 400 for the second process automation server. For example, the operating data obtained at block 402 in implementing method 400 for the first process automation server can include processor data for processor(s) that implement the first process automation server but exclude processor data for processor(s) that implement the second process automation server, and the operating data obtained at block 402 in implementing method 400 for the second process automation server can include processor data for processor(s) that implement the second process automation server but exclude processor data for processor(s) that implement the first process automation server.

In some implementations that implement multiple instances of method 400 within a given process automation facility in parallel with one another, each instance of method 400 can optionally utilize different trained server anomaly machine learning models. For example, a first instance of method 400 can utilize a first trained server anomaly machine learning model fine-tuned for a first process automation server, and a second instance of method 400 can utilize a second trained server anomaly machine learning model fine-tuned for a second process automation server.

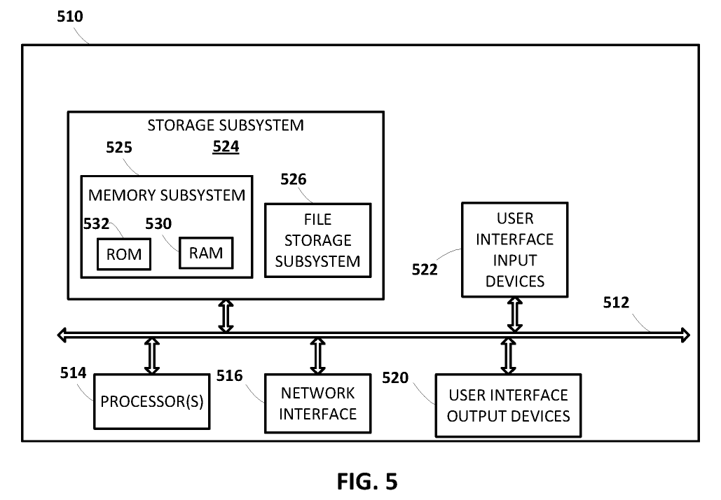

FIG. 5 is a block diagram of an example computing device 510 that may optionally be utilized to perform one or more aspects of techniques described herein. For example, computing device 510 is an example of a computing device that can implement all or parts of alarm configuration service and/or, optionally, all or parts of some DCN(s). Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of method 300 of FIG. 3 and/or of method 400 of FIG. 4, as well as to implement various components depicted in FIGS. 1 and 2.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In some implementations, a method implemented by processor(s) is provided and includes obtaining a current set of operating data. The current set of operating data includes multiple disparate types of data. Each of the disparate types of data reflects a corresponding operating state of a corresponding component of a process automation facility. For each of the multiple disparate types of data, a corresponding most recently determined instance thereof is included. The method further includes processing, using a trained machine learning model, the current set of operating data to generate output that indicates a current operating condition of a process automation server. The process automation server operates on server hardware that is located within the process automation facility. The process automation server controls one or more aspects of a process performed within the process automation facility. The method further includes determining, based on the output generated using the machine learning model, whether the current operating condition of the process automation server is normal. The method further includes, in response to determining, based on the output generated using the machine learning model, that the current operating condition of the process automation server is not normal, causing automatic performance of at least one remediating action that seeks to remedy the not normal current operating condition of the process automation server.

In some implementations, the disparate types of data, included in the current set of operating data, can include: processor data that reflects an extent of usage of a hardware processor; memory data that reflects an extent of usage of hardware memory; network data that reflects status of a communication network; and/or log data that reflects one or more logs generated by the process automation server.

In some of those implementations, the disparate types of data can include the processor data and the hardware processor can be operating the server.

In some versions of those implementations, the disparate types of data can include the memory data and the hardware memory can be utilized in operating the server.

In some implementations, the at least one remediating action can include: rendering of a human perceptible alert that is descriptive of the not normal current operating condition of the server; and/or causing a backup process automation server to at least temporarily replace the process automation server.

In some of those implementations, the at least one remediating action can include causing the backup process automation server to at least temporarily replace the process automation server.

In some versions of those implementations, the backup process automation server operates on additional server hardware and, at a time of determining that the current operating condition of the process automation server is not normal, can be operating in preparation of controlling the one or more aspects of the process but without actively controlling the one or more aspects of the process, and causing the backup process automation server to at least temporarily replace the process automation server includes causing the backup process automation server to initiate actively controlling the one or more aspects of the process.

In some implementations, the output can reflect a non-binary likelihood that the current operating condition of the process automation server is not normal and causing automatic performance of the remediating action that seeks to remedy the not normal current operating condition of the server includes: selecting, from a superset of remediating actions and based on the non-binary likelihood satisfying one or more first conditions, the remediating action without selecting an alternate remediating action, where the alternate remediating action is selected when the one or more first conditions are not satisfied.

In some implementations, the server hardware, on which the process automation server operates, can include a distributed control node (DCN) that includes one or more I/Os to which one or more sensors and/or one or more actuators are connected.

In some implementations, the current set of operating data can further include, for each of the multiple disparate types of data, a corresponding next most recently determined instance thereof.

In some implementations, the method can further include: receiving human feedback that is responsive to the remediating action; determining a supervised label based on the human feedback; and using the current set of operating data, and the supervised label, to further train the trained machine learning model.

In some implementations, the trained machine learning model can be trained based on historical training instances, where each of the historical training instances includes training instance input that includes corresponding real historical operating data and training instance output that includes a corresponding supervised label for the corresponding real historical operating data.

In some of those implementations, the historical training instances, based on which the trained machine learning model is initially trained, can be generated based on historical operating data from additional process automation facilities that differ from the process automation facility; and the historical training instances, based on which the trained machine learning model is fine-tuned after the initial training, can be generated based on historical operating data from the process automation facility.

In some implementations, the one or more processors, that implement the method, can be of a distributed control node (DCN) that is separate from the server hardware on which the process automation server operates.

What is claimed is:

1. A method implemented by one or more processors, the method comprising:
obtaining a current set of operating data, the current set of operating data including:
multiple disparate types of data, each of the disparate types of data reflecting a corresponding operating state of a corresponding component of a process automation facility, and
for each of the multiple disparate types of data, a corresponding most recently determined instance thereof;
processing, using a trained machine learning model, the current set of operating data to generate output that indicates a current operating condition of a process automation server,
wherein the process automation server operates on server hardware that is located within the process automation facility, and
wherein the process automation server controls one or more aspects of a process performed within the process automation facility;
determining, based on the output generated using the machine learning model, whether the current operating condition of the process automation server is normal;
in response to determining, based on the output generated using the machine learning model, that the current operating condition of the process automation server is not normal:
causing automatic performance of at least one remediating action that seeks to remedy the not normal current operating condition of the process automation server.

2. The method of claim 1, wherein the disparate types of data, included in the current set of operating data, include:
processor data that reflects an extent of usage of a hardware processor;
memory data that reflects an extent of usage of hardware memory;
network data that reflects status of a communication network; and/or
log data that reflects one or more logs generated by the process automation server.

3. The method of claim 2, wherein the disparate types of data include the processor data and wherein the hardware processor is operating the server.

4. The method of claim 2, wherein the disparate types of data include the memory data and wherein the hardware memory is utilized in operating the server.

5. The method of claim 1, wherein the at least one remediating action includes:
rendering of a human perceptible alert that is descriptive of the not normal current operating condition of the server; and/or
causing a backup process automation server to at least temporarily replace the process automation server.

6. The method of claim 5, wherein the at least one remediating action includes causing the backup process automation server to at least temporarily replace the process automation server.

7. The method of claim 6,
wherein the backup process automation server operates on additional server hardware and, at a time of determining that the current operating condition of the process automation server is not normal, is operating in preparation of controlling the one or more aspects of the process but without actively controlling the one or more aspects of the process, and
wherein causing the backup process automation server to at least temporarily replace the process automation server comprises causing the backup process automation server to initiate actively controlling the one or more aspects of the process.

8. The method of claim 1, wherein the output reflects a non-binary likelihood that the current operating condition of the process automation server is not normal and wherein causing automatic performance of the remediating action that seeks to remedy the not normal current operating condition of the server comprises:
selecting, from a superset of remediating actions and based on the non-binary likelihood satisfying one or more first conditions, the remediating action without selecting an alternate remediating action,
wherein the alternate remediating action is selected when the one or more first conditions are not satisfied.

9. The method of claim 1, wherein the server hardware, on which the process automation server operates, includes a distributed control node (DCN) that includes one or more I/Os to which one or more sensors and/or one or more actuators are connected.

10. The method of claim 1, wherein the current set of operating data further includes, for each of the multiple disparate types of data, a corresponding next most recently determined instance thereof.

11. The method of claim 1, further comprising:
receiving human feedback that is responsive to the remediating action;
determining a supervised label based on the human feedback; and
using the current set of operating data, and the supervised label, to further train the trained machine learning model.

12. The method of claim 1, wherein the trained machine learning model is trained based on historical training instances, wherein each of the historical training instances include training instance input that includes corresponding real historical operating data and training instance output that includes a corresponding supervised label for the corresponding real historical operating data.

13. The method of claim 12,
wherein the historical training instances, based on which the trained machine learning model is initially trained, are generated based on historical operating data from additional process automation facilities that differ from the process automation facility; and
wherein the historical training instances, based on which the trained machine learning model is fine-tuned after the initial training, are generated based on historical operating data from the process automation facility.

14. The method of claim 1, wherein the one or more processors, that implement the method, are of a distributed control node (DCN) that is separate from the server hardware on which the process automation server operates.

15. A system comprising:
one or more processors; and
memory storing instructions that, when executed, cause the one or more processors to:
obtain a current set of operating data, the current set of operating data including:
multiple disparate types of data, each of the disparate types of data reflecting a corresponding operating state of a corresponding component of a process automation facility, and
for each of the multiple disparate types of data, a corresponding most recently determined instance thereof;
process, using a trained machine learning model, the current set of operating data to generate output that indicates a current operating condition of a process automation server,
wherein the process automation server operates on server hardware that is located within the process automation facility, and
wherein the process automation server controls one or more aspects of a process performed within the process automation facility;
determine, based on the output generated using the machine learning model, whether the current operating condition of the process automation server is normal; and
in response to determining, based on the output generated using the machine learning model, that the current operating condition of the process automation server is not normal:
cause automatic performance of at least one remediating action that seeks to remedy the not normal current operating condition of the process automation server.

16. The system of claim 15, wherein the disparate types of data, included in the current set of operating data, include two or more of:
processor data that reflects an extent of usage of a hardware processor;
memory data that reflects an extent of usage of hardware memory;
network data that reflects status of a communication network; and/or
log data that reflects one or more logs generated by the process automation server.

17. The system of claim 16, wherein the disparate types of data include the processor data and the memory data and wherein the hardware processor and the hardware memory are utilized in operating the server.

18. The system of claim 15, wherein the at least one remediating action includes:
causing a backup process automation server to at least temporarily replace the process automation server,
wherein the backup process automation server operates on additional server hardware and, at a time of determining that the current operating condition of the process automation server is not normal, is operating without actively controlling the one or more aspects of the process, and
wherein causing the backup process automation server to at least temporarily replace the process automation server comprises causing the backup process automation server to initiate actively controlling the one or more aspects of the process.

19. The system of claim 15, wherein the output reflects a non-binary likelihood that the current operating condition of the process automation server is not normal and wherein causing automatic performance of the remediating action that seeks to remedy the not normal current operating condition of the server comprises:
selecting, from a superset of remediating actions and based on the non-binary likelihood satisfying one or more first conditions, the remediating action without selecting an alternate remediating action,
wherein the alternate remediating action is selected when the one or more first conditions are not satisfied.

20. The system of claim 15, wherein the server hardware, on which the process automation server operates, includes a distributed control node (DCN) that includes one or more I/Os to which one or more sensors and/or one or more actuators are connected.
